(19) United States
(12) Patent Application Publication
(10) Pub. No.: US 2024/0142408 A1
(43) Pub. Date: May 2, 2024

(54) METHOD AND APPARATUS FOR DAMAGE DETECTION IN PIPELINES USING NON-CONTACT ELECTRICAL-MAGNETIC-VIBRATION-ULTRASONIC INTERACTIONS

(71) Applicant: Mistras Group, Inc., Princeton, NJ (US)

(72) Inventors: Valery Godinez-Azcuaga, Princeton Junction, NJ (US); Stephen Westwood, Calgary (CA); Mike Niosi, Calgary (CA); Dimitri Donskoy, Hoboken, NJ (US)

(21) Appl. No.: 18/495,732

(22) Filed: Oct. 26, 2023

Related U.S. Application Data
(60) Provisional application No. 63/419,697, filed on Oct. 26, 2022.

(51) Int. Cl. G01N 29/06; G01N 29/12

(52) U.S. Cl. CPC G01N 29/069; G01N 29/12; G01N 2291/014; G01N 2291/0289

(57) ABSTRACT

The present disclosure provides pipe scanning systems suitable for integrity and reliability inspection of pipelines via detection of nonlinear interactions between high frequency (HF) resonating waves and low frequency (LF) resonating waves generated within the pipeline. The pipe scanning system may include resonation generating devices to generate HF and LF resonating waves within a pipeline as well as sensors. The sensors may be configured to detect nonlinear interactions between HF and resonating wave modalities within in the pipeline which occur when pipeline wall defects are exposed to HF and LF resonating wave modalities simultaneously. The pipe scanning systems may calculate damage parameter values based on the detected nonlinear interactions and detect locations of pipeline wall damage based on the calculated damage parameter values. The pipe scanning techniques described herein provide improved sensitivity of defect detection and reduced false alarm rate compared to existing techniques for pipeline integrity inspection.

### TECHNICAL FIELD

The present invention relates generally to structural integrity testing and more specifically to devices and techniques for identifying structural defects present in structures, such as pipes, piping, or pipelines.

### BACKGROUND OF THE INVENTION

Pipelines are an efficient way to transport many different types of fluids, such as natural gas, oil, liquid butane, liquid propane, or other fluids, long distances. However, such pipelines may be subjected to various conditions that may degrade the structural integrity of the pipeline over time. Various inspection technologies may be utilized to detect defects in the wall of a pipeline (e.g., cracks, dents, or corrosion). For example, smart pipeline inspection gauges (PIGs) may be configured to navigate along a pipeline while inspecting for defects using non-destructive testing instruments (NDIs). NDIs equipped on PIGs may implement non-destructive testing methods for measuring wall thickness and detecting damage on long pipelines. Example non-destructive testing methods used for detecting pipeline defects include magnetic flux leakage (MFL), ultrasonic, vibration, eddy current, guided wave, electro-magnetic acoustic transduction (EMAT), and vibro-acoustic modulation-based methods.

Some NDIs have a higher sensitivity for defect detection than that of other NDIs. NDIs having a higher detection sensitivity are generally beneficial because such NDIs provide for a greater likelihood that pipeline defects are detected and may then be repaired. However, NDIs having a higher detection sensitivity are also typically more likely to generate greater numbers of defect false alarms. Defect false alarms are undesirable because they generally lead to costly pipeline flow stoppages or redirects often followed by similarly costly pipeline section disassembly executed in an effort to repair non-existent or trivial defects.

Additionally, some NDIs utilize detection baselines based on characteristics (e.g., wall thickness, pipe grade, pipe bulk material, presence of pipeline coating, or presence of pipeline insulation) of the pipeline section under inspection as a reference against which to compare inspection results when evaluating whether defects are present. Another challenge with respect to evaluating the integrity and reliability of pipelines related to the use of such NDIs is that pipeline characteristics may vary from section to section of pipeline and, therefore, a particular detection baseline may be appropriate for one section but inappropriate for another section. For example, some NDIs may use pipeline wall thickness as a baseline and may evaluate that a defect is detected when an inspected wall thickness is less than that baseline thickness, but different pipe having varying wall thicknesses may have been used from section to section of the length of pipeline to be inspected. Determining particular detection baselines appropriate for each distinct pipeline section within a length of pipeline to be inspected (e.g., determining the actual wall thickness baseline for each section of a length of pipeline) may be time consuming and costly.

### BRIEF SUMMARY OF THE INVENTION

The present invention is directed to pipe scanning systems. More particularly, the present invention is directed to pipe scanning systems that detect pipeline wall defects/damage (e.g., cracks, dents, corrosion, etc.) at least via detection of nonlinear interactions between high frequency resonating waves and low frequency resonating waves generated within the pipeline. The pipe scanning system may include high frequency (HF) resonation generating device(s) and low frequency (LF) generating device(s) which may be configured to generate HF and LF resonating waves, respectively, within the pipeline via electromotive interactions. Sensor(s) may also be included in the pipe scanning system that may be configured to detect nonlinear interactions between HF resonating wave modalities and LF resonating wave modalities within in the pipeline (e.g., amplitude and/or frequency modulations of the HF resonating wave modalities by the LF resonating wave modalities) which occur when pipeline wall defects are exposed to HF and LF resonating wave modalities simultaneously. A communications and control system included in the pipe scanning system may receive the detected nonlinear interaction signals (e.g., modulated signals) via the sensor(s), process the received signals, extract damage-related data features from the process from the processed signals, calculate damage parameter (DP) values associated with particular locations along a section of pipeline based on the extracted features, and detect damaged pipeline wall locations based on the calculated (DP) values. Utilizing pipe scanning systems which can for pipeline defects via detection of nonlinear interactions between HF and LF resonating wave modalities present within the pipeline provides noticeably improved probability of defect detection over currently available pipe scanning systems while also providing noticeably reduced susceptibility to false alarms from that of currently available systems.

In some aspects, the pipe scanning system may be configured as a measurement module to be implemented on a pipeline inspection gauge (PIG). The pipe scanning system may be the singular measurement module included on a PIG or may be included among one or more additional measurement modules which may also be configured for pipeline damage detection or may be configured for detection/measurement of other pipeline characteristics. In some aspects, the pipe scanning device measurement module may be affixed to a PIG or may be trailed behind a PIG in order to traverse a length of pipeline for scanning.

In some aspects, the communications and control system of the pipe scanning system may be configured to determine a distribution of calculated DP values along a section of pipeline and detect pipeline damage locations by comparing calculated DP values to a DP threshold value. In some aspects, the DP threshold value may be updated dynamically as the pipe scanning systems scans a section of pipeline (e.g., periodically average previously calculated DP values and update the threshold DP value based on the average). Alternatively, or in addition to threshold comparison, in some aspects, the communications and control system may be configured to detect sudden increases or spikes in the DP value distribution for a section of pipeline and detect pipeline wall damage at pipeline locations associated with those spikes (e.g., a change in DP value of X % representing a spike above the baseline DP value). Utilizing either or both approaches eliminates the need for absolute calibration of the detection system and further improves the system's sensitivity of detection and lower the false alarm rate. Moreover, in additional to pipeline damage detection, the above-described detection approaches may also be used for other purposes, such as to detect pipe characteristics (e.g., thickness, grade, coating, etc.) based on the baseline DP values, thereby providing a mechanism to characterize new features of a pipeline (e.g., enabling identification and quantification of the structure of a pipeline).

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a block diagram of a pipe scanning system in accordance with aspects of the present disclosure;

FIG. 2 is a block diagram illustrating exemplary operation of a pipe scanning system in accordance with aspects of the present disclosure;

FIG. 3 is a block diagram illustrating a pipe scanning system implemented as a pipe inspection gauge (PIG) measurement module in accordance with aspects of the present disclosure;

FIG. 4 is a flow diagram of a method for scanning a pipeline for damage in accordance with aspects of the present disclosure;

FIG. 5 is a block diagram illustrating additional aspects of a pipe scanning system in accordance with of the present disclosure;

FIG. 6 is a block diagram illustrating an alternative implementation of a pipe scanning system that utilizes a single magnetic field source for both resonation and detection in accordance with aspects of the present disclosure;

FIG. 7 is a block diagram illustrating an alternative implementation of a pipe scanning system that generates low frequency resonating waves via variable magnetic attraction (VAM) in accordance with aspects of the present disclosure;

FIG. 8 is a block diagram illustrating an alternative implementation of a pipe scanning system that generates resonating waves utilizing a plurality of excitation modules in accordance with aspects of the present disclosure;

FIG. 9A is a graph illustrating an exemplary approach for detecting pipeline defects based on comparing calculated DP values to a DP threshold in accordance with aspects of the present disclosure;

FIG. 9B is a graph illustrating an exemplary approach for detecting pipeline defects based on detecting sudden increases in calculated DP values in accordance with aspects of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses, or which render other details difficult to perceive may have been omitted. It should be understood, of course, that this disclosure is not limited to the particular embodiments illustrated herein.

### DETAILED DESCRIPTION OF THE INVENTION

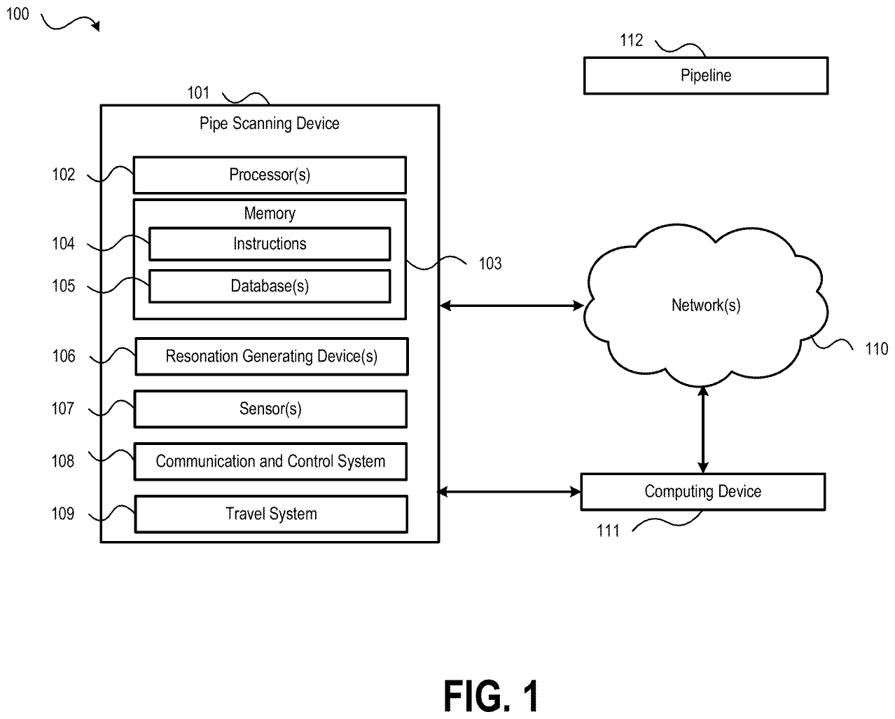

Referring to FIG. 1, a block diagram of a pipe scanning system in accordance with aspects of the present disclosure is shown as a pipe scanning system 100. As described in more detail below, pipe scanning systems in accordance with the present disclosure may scan pipelines for defects. Scanning the pipeline may comprise generating resonating waves within the pipeline and detecting interactions between the generated resonating waves indicating damaged locations of the pipeline walls (e.g., cracks, dents, corrosion, etc.). The scans may include circumferential scans obtained by traversing the pipe scanning system, or at least scanning sensor components of the scanning system, around the circumference of an exterior or an interior of the pipeline. As the scanning is performed, scan data (e.g., processed signal data) may be obtained for analysis, which may be used to identify defects present on the pipeline. As will be described in more detail below, pipe scanning systems in accordance with the present disclosure may be particularly well suited to detect defects with a high probability of detection and a low susceptibility to false alarms. Moreover, it is to be understood that while aspects of the pipe scanning systems disclosed herein are primarily described with reference to scanning pipelines (e.g., insulated and non-insulated pipelines), the disclosed scanning systems and techniques may readily be applied to any type of pipe or piping and are not limited to use with pipelines.

As shown in FIG. 1, the pipe scanning system may include a pipe scanning device 101. The pipe scanning device 101 includes one or more processors 102, a memory 103, one or more resonation generating device(s), one or more sensor(s) 107, a communication and control system 108, and a travel system 109. The one or more processors 102 may include one or more microcontrollers, application specific integrated circuits (ASICs), field programmable gate arrays (FPGAs), central processing units (CPUs) having one or more processing cores, or other circuitry and logic configured to facilitate the operations of the pipe scanning device 101 in accordance with aspects of the present disclosure. The memory 103 may include random access memory (RAM) devices, read only memory (ROM) devices, erasable programmable ROM (EPROM), electrically erasable programmable ROM (EEPROM), one or more hard disk drives (HDDs), one or more solid state drives (SSDs), flash memory devices, network accessible storage (NAS) devices, or other memory devices configured to store data in a persistent or non-persistent state. As shown in FIG. 1, the memory 103 may store instructions 104. The instructions 104 may be executable by the one or more processors 102 to perform operations of the pipe scanning device 101, such as to control scanning of a pipeline or other operations. Additionally, the memory 103 may store information at one or more databases 105. Exemplary types of information that may be stored at the one or more databases 105 may include scan data captured by the pipe scanning device 101, information associated with scanning operations performed by the pipe scanning device 101 (e.g., timestamp data indicating the date and time when a particular scan occurred, a number of scans performed for a particular pipeline, etc.), scan control data (e.g., information about the number of scans to be performed, a degree of the scanning, such as a full 360° circumference scan or a partial circumference scan, etc.), or other types of information.

The sensor(s) 107 may operate in combination with the resonation generating device(s) 106 to capture scan data during scanning of a pipeline. For example, in some embodiments, the resonation generating device(s) 106 may include at least one high frequency (HF) electric field source, at least one low frequency (LF) electric field source, and at least one magnetic field source configured such that electromotive interactions between the magnetic field(s) emitted by the magnetic field source(s) and the electric field(s) emitted by the HF electric field source(s) (i.e., HF electric field(s)) generate HF resonating wave modalities within the pipeline (e.g., ultrasonic wave modalities) and such that electromotive interactions between the magnetic field(s) emitted by the magnetic field source(s) and the electric field(s) emitted by the LF electric field source(s) (i.e., LF electric field(s)) generate LF resonating wave modalities within the pipeline (e.g., vibrational wave modalities). Further, in some embodiments, the sensor(s) 107 may include at least one electric field receiver and at least one magnetic field source configured such that nonlinear interactions between HF resonating wave modalities and LF resonating wave modalities within in the pipeline (e.g., frequency and/or amplitude modulations of the HF resonating wave modalities by the LF resonating wave modalities) corresponding to pipeline wall defects may be detected as electronic signals to be transmitted to communication and control system 108 as scan data. A pipe scanning device 101 that scans the pipeline 112 for defects via detection of nonlinear interactions between HF resonating waves and LF resonating waves within pipeline 112 provides noticeably improved probability of defect detection over currently available pipe scanning systems while also providing noticeably reduced susceptibility to false alarms from that of currently available systems.

It is to be understood that the specific configuration described above is provided for purposes of illustration, rather than by way of limitation and that other sensor/resonation generation configurations may be utilized in accordance with aspects of the present disclosure. As additional non-limiting examples, scanning systems of the present disclosure may utilize, as an HF electric field source, meander-shape conductors, standard coil conductors, or a combination of thereof, configured with a particular inter-conductor spacing so as to emit electric fields alternating at a specific frequency and may utilize, as an LF electric field source, unidirectional conductors configured to emit electric fields alternating at a specific frequency lower than the specific frequency of the electric fields emitted by the HF electric field source. Additionally, in some embodiments, the magnetic field source(s) may include at least one permanent magnet, at least one electromagnet, or a combination thereof. In some embodiments, the HF electric field source may be driven by a driving signal supplied by an HF signal generator and tuned to the desired alternation frequency for the HF electric fields and the LF electric field source may be driven by a driving signal supplied by an LF signal generator and tuned to the desired alternation frequency for the LF electric fields. In some embodiments, amplification may be applied to the driving signals for the HF electric field source and for the LF electric field source. In other embodiments, HF resonating waves, LF resonating waves, or both may be generated via variable magnetic attraction (VAM) between a time-varying magnetic field and a surface of pipeline 112. In some aspects, a single magnetic field source may be utilized for both generation of resonating waves within pipeline 112 as well as detection of nonlinear interactions of those resonating waves corresponding to defects of pipeline 112. For example, the same magnetic field source which provides the magnetic field(s) for generating resonating waves within pipeline 112 via electromotive interactions between the magnetic field(s) and the HF or LF electric field(s) may also be utilized in conjunction with a Hall sensor to implement a magnetic flux leakage (MFL) sensor by which nonlinear interactions between the HF and LF resonating waves within pipeline 112 may be detected. Moreover, some embodiments of pipe scanning device 101 may exclude the resonation generating device(s) 106 and resonating waves inside pipeline 112 utilized for detection of defects to pipeline 112 may be generated using devices separate from pipe scanning device 101 and positioned elsewhere, either laterally, circumferentially, or both, on pipeline 112 relative to pipe scanning device 101. Additionally, it is noted that sensors capable of detection over a wider area of pipe wall may be preferred as larger sections of the pipeline may be scanned per pass, which may enable the scanning of the pipeline to be performed more rapidly and with fewer passes.

The communication and control system 108 comprise at least one or more processors configured to control operations of the pipe scanning device 101. For example, the communication and control system 107 may be communicatively coupled to the resonation generating device(s) 106 to control generation of resonating waves within the pipeline and communicatively coupled to sensor(s) 106 to receive scan data based on resonating wave interactions detected by sensor(s) 106. In some aspects, the communication and control system 108 may be configured to store the scan data at the one or more databases 105. It is noted that storing the scan data at the one or more databases 105 may require additional memory to be provided, such as additional HDDs or SSDs, which may increase the weight of the pipe scanning device 101, which may be undesirable. In additional or alternative aspects, the communication and control system 108 may be configured to transmit or stream the scan data to a remote computing device 1111 instead of storing the scan data at the one or more databases 105. Streaming the scan data to the remote computing device 1111 may enable the pipe scanning device 101 to be lighter weight, which may be beneficial as a lighter weight pipe scanning device 101 may minimize the impact of the scanning process on the structure of the pipeline. Additionally, lighter weight pipe scanning devices may be less costly to transport, install on a pipeline for scanning, and uninstall after completion of scanning.

In some aspects, the pipe scanning device 101 may be configured to record or output information associated with a location where the scan data output to the computing device 111 was captured. For example, the pipe scanning device 101 may be configured to associate location information (e.g., a foot marker) with the scan data, such as to indicate the scan data being output was captured at “X” foot marker of the pipeline being scanned. The scan data may also be timestamped to reflect the time that the specific section of the pipeline corresponding to the location information was scanned. In an aspect, the pipe scanning device 101 may be initialized with a starting location (e.g., a starting foot marker) and may automatically adjust the location as the pipe scanning system is moved laterally along a length of the pipeline, either manually or automatically. In some aspects, other forms of providing location information may be utilized, such as a global positioning system (GPS) and the like. In aspects, a new file (e.g., an Excel file, CSV file, etc.) may be created for each scanned section of the structure. The files corresponding to the scan data captured by the pipe scanning device 101 may be created using a naming convention, such as to include the pipeline name, the section or location where the scan occurred, and a timestamp (e.g., “pipeline-X_126_07012021-14:23” indicating that the file corresponds to a scan of pipeline “X” at foot marker 126 on Jul. 1, 2021, at 2:23 PM).

To facilitate communication between the communication and control system 108 and the remote computing device 111, the communication and control system 108 may include one or more communication interfaces. The communication interfaces may be configured to communicatively couple the communication and control system 108 to the remote computing device 111 via one or more networks 110 using wired or wireless communication links established according to one or more communication protocols or standards (e.g., an Ethernet protocol, a transmission control protocol/internet protocol (TCP/IP), an Institute of Electrical and Electronics Engineers (IEEE) 802.11 standard, an IEEE 802.16 standard, a 3rd Generation (3G) communication standard, a 4th Generation (4G)/long term evolution (LTE) communication standard, a 5th Generation (5G) communication standard, a peer-to-peer communication protocol, and the like).

In addition to providing functionality for controlling operations of the resonation generation devices(s) 106, the sensor(s) 107, and the transmission of the scan data to the remote computing device 111, the communication and control system 108 may also be configured to provide control signals to the travel system 109. For example, the pipe scanning device 101 may be configured to perform circumferential scanning of a pipeline 112. To perform circumferential scanning, the travel system 109 may include a rotation system that may be secured to an exterior or interior surface of the pipeline 112. The rotation system may include a guide or track that extends around the circumference of the pipeline 112. The travel system 109 may also include a drive carriage configured to be secured to the rotation system. The drive carriage may include a motor and one or more traction components to enable the drive carriage to move along the rotation system (e.g., the guide or track) and navigate about the circumference of the pipeline 112. The resonation generation device(s) 106, the sensor(s) 107, and the communication and control system 110 may be coupled to the drive carriage so that the pipe scanning device 101 may be moved about the circumference of the pipeline 112 to perform scanning of the pipeline at a particular location where the travel system is located. In some aspects, the travel system 109 may also include lateral travel members configured to move the pipe scanning device 101 laterally along a length of the pipeline 112 in order to scan additional sections of the pipeline 112 (e.g., without having to remove and reinstall the travel system 109). In other embodiments, pipe scanning device 101 may be configured to scan the entire circumference of a lateral section of pipeline 112 without rotating circumferentially around the pipeline section (e.g., remaining in one circumferential position on the exterior or interior of pipeline 112 and scanning while traversing pipeline 112 only in the lateral direction).

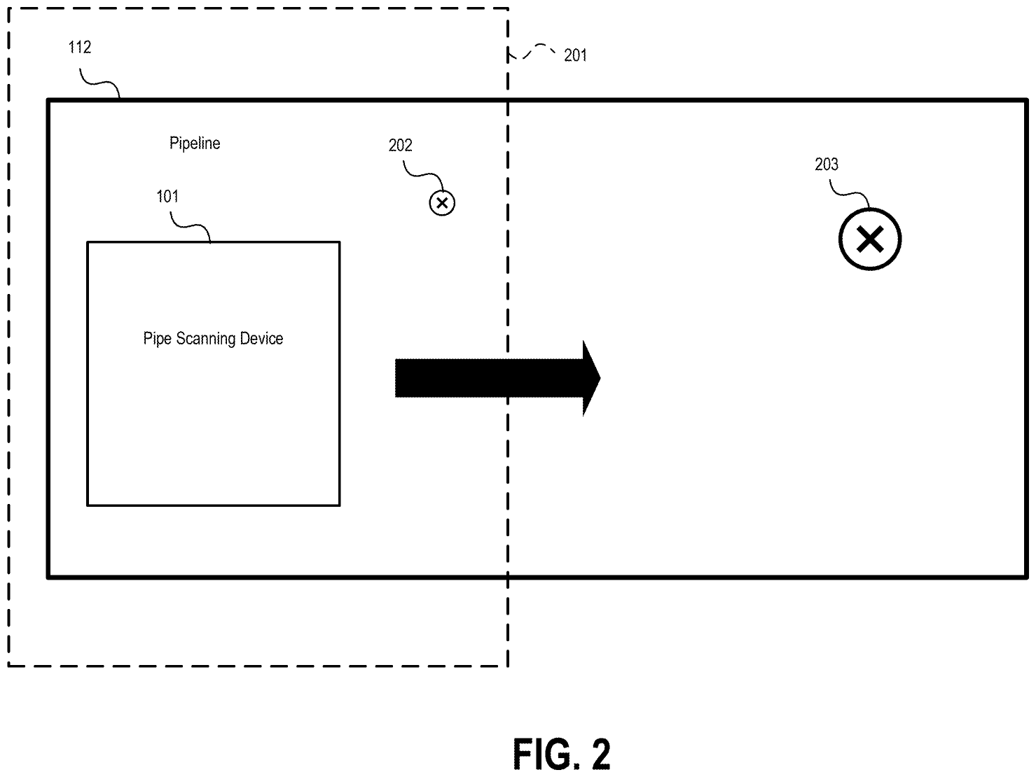

Referring to FIG. 2, a diagram is shown illustrating the operation of pipe scanning 101 in accordance with aspects of the present disclosure. In FIG. 2, pipe scanning device 101 is shown scanning for defects while travelling laterally down the interior of pipeline 112 wherein pipe scanning device 101 features an area of detection 201 and wherein pipeline 112 includes small defect 202 and large defect 203. In some aspects, area of detection 201 may represent the extent of a portion of pipeline 112 for which pipe scanning device 101 may detect defects for a given lateral and circumferential position of pipe scanning device 101 along pipeline 112. In the present aspect, small defect 202 may be detectable by pipe scanning device 101 because it falls within area of detection 201 whereas large defect 203 may not be detectable by pipe scanning device 101 because it does not fall within area of detection 201. However, as pipe scanning device 101 travels laterally down pipeline 112, large defect 203 may become detectable by pipe scanning device 101 as large defect 203 becomes encompassed by area of detection 201. Small defect 202 and large defect 203 may comprise the same type of pipeline damage (e.g., cracks, dents, corrosion, etc.) to the wall of pipeline 112 but wherein small defect 202 comprises a lesser extent of structural weakness to pipeline 112 than large defect 203. In some aspects, both small defect 202 and large defect 203 may be detectable by pipe scanning device 101 when encompassed by area of detection 201, but small defect 202 may constitute damage so insubstantial as to be considered a false alarm by pipe scanning device 101 whereas large defect 203 may not be. For example, in some aspects, sensor(s) 107 may detect nonlinear interactions between HF and LF resonating waves caused by small defect 202 but logic (e.g., comparison to a threshold) internal to communication and control system 108 may cause pipe scanning device 101 to determine that the intensity of the nonlinear interactions caused by small defect 202 are too insubstantial to report to the user (e.g., via representation in a graphical report, immediate visual/auditory indication, recordation in a defect log, etc.). Whereas, in the aforementioned aspect, sensor(s) 107 may detect nonlinear interactions between HF and LF resonating waves caused by large defect 203 and logic internal to communication and control system 108 may cause pipe scanning device 101 to determine that the intensity of the nonlinear interactions caused by large defect 203 are substantial enough to report to the user.

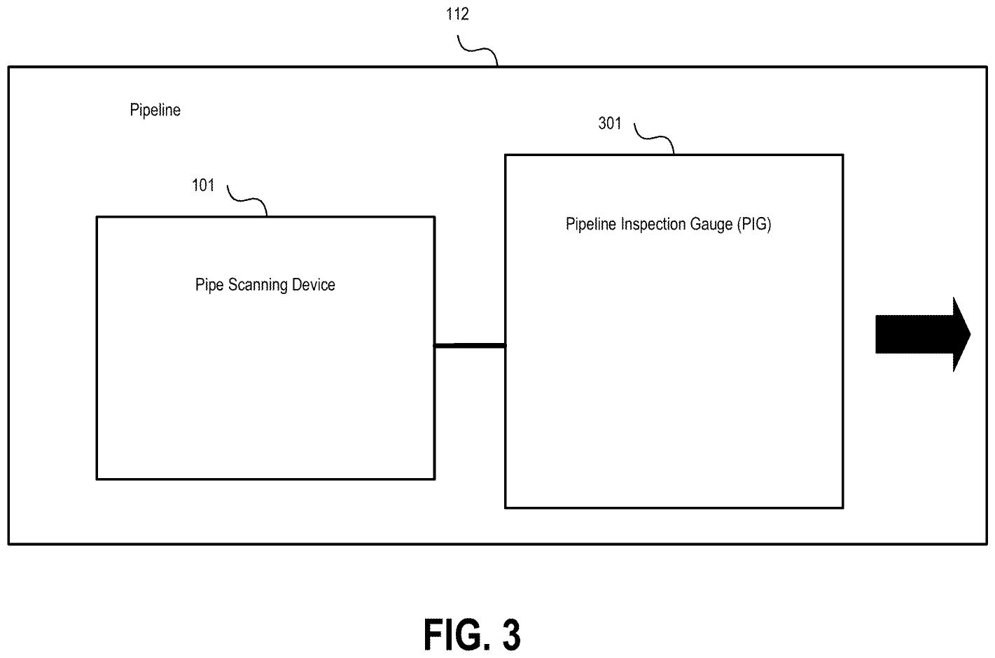

Referring to FIG. 3, a diagram is shown illustrating pipe scanning device 101 scanning for defects while coupled to a PIG 301 that is travelling laterally down the interior of pipeline 112 in accordance with aspects of the present disclosure. In some embodiments, PIG 301 includes a travel system configured as described above with respect to travel system 109. In some embodiments, pipe scanning device 101 may lack travel system 109, or may include an unmotorized version of travel system 109 and may rely of the travel system of PIG 301 for travelling laterally and/or circumferentially along the interior or exterior of pipeline 112. In some embodiments, pipe scanning device 101 may constitute a measurement module coupled to PIG 301. In some embodiments, a measurement module coupled to PIG 301 may house resonation generating device(s) 106 and sensor(s) 107 and may implement the generation of HF and LF resonating waves within pipeline 112 and the detection of nonlinear interactions of resonating waves within pipeline 112 whereas processor(s) 102, memory 103, and communication and control system 108 may be housed elsewhere on PIG 301. In some embodiments, resonation generating device(s) 106 and sensor(s) 107 may be housed within a measurement module coupled to PIG 301 and processor(s) 102, memory 103, and communication and control system 108 be housed at locations external to PIG 301 and communicatively coupled to resonation generating device(s) 106 and sensor(s) 107. In some embodiments, PIG 301 may comprise one or more sensor(s) in addition to a measurement module housing sensor(s) 107 and the one or more additional sensor(s) may be configured to detect characteristics of pipeline 112 that differ from characteristics detected by sensor(s) 107, the same as characteristics detected by sensor(s) 107, or a combination thereof. In some embodiments, pipe scanning device may scan for defects while being pulled along behind PIG 301 as PIG 301 travels laterally and/or circumferentially along the interior or exterior of pipeline 112.

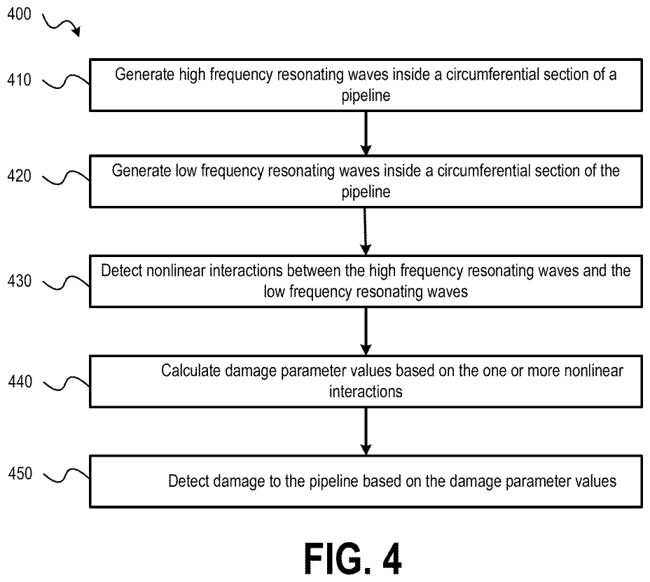

Referring to FIG. 4, an operational flow diagram is shown illustrating an exemplary method 400 for implementing a pipe scanning system in accordance with aspects of the present disclosure. In the example of FIG. 4, pipe scanning system 100 operates as follows: the resonation generating device(s) 106 generate HF resonating waves and LF resonating waves inside a circumferential section of pipeline 112, as noted in blocks 410 and 420. In some embodiments, resonation generating device(s) 106 may comprise one or more devices configured to emit HF resonating waves within pipeline 112 and one or more devices configured to emit LF resonating waves within pipeline 112. At block 430, the sensor(s) 107 detect nonlinear interaction between the HF resonating waves and the LF resonating waves within pipeline 112 resulting from one or more defects within the wall of pipeline 112. At block 440, communication and control system 108 calculates damage parameter (DP) values based on signals representing the one or more nonlinear interactions received by communication and control system 108 from sensor(s) 107, as described in more detail below. In block 450, pipe scanning system 100 detects damage to pipeline 112 (e.g., defects within the wall of pipeline 112) based on the calculated DP values. In some embodiments, communications and control system 108 may be configured to detect damage to the pipeline based on the DP values and indicate the presence and location of the damage to a user upon detection. In other embodiments, communications and control system 108 may be configured to summarize DP values calculated over a length of pipeline for a user and the user may make a determination as to whether the DP values reported by communications and control system 108 indicate damage to the pipeline.

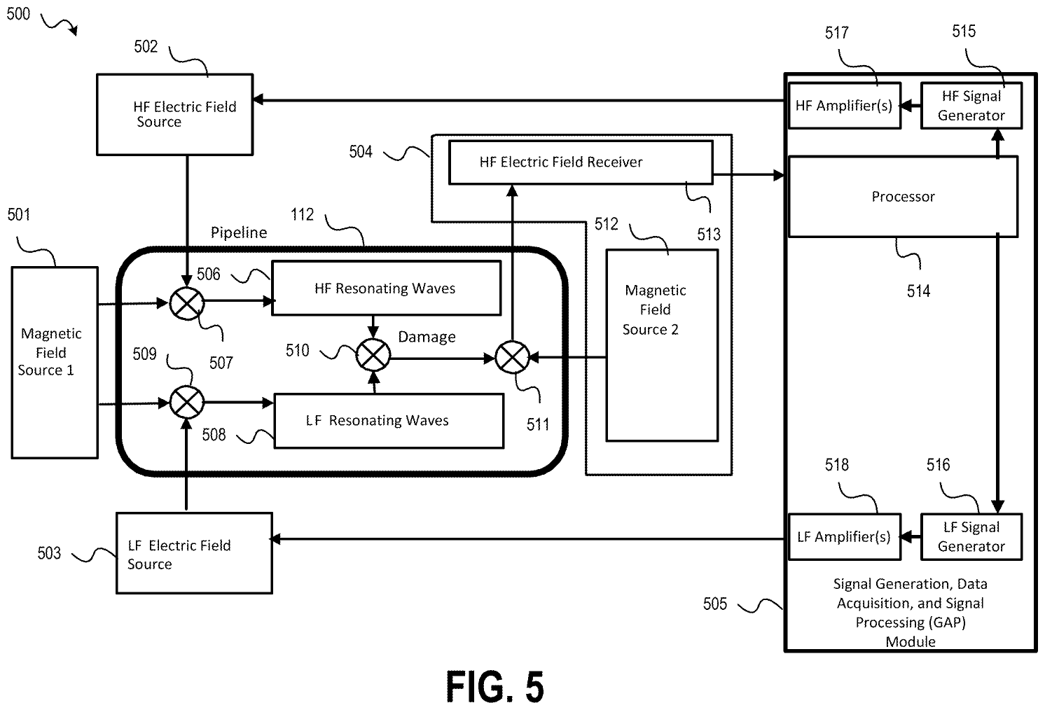

Referring to FIG. 5, a block diagram of pipe scanning device 500 is shown, which illustrates an exemplary embodiment of pipe scanning device 101 in accordance with aspects of the present disclosure. For example, device 500 includes an exemplary implementation of resonation generating devices 106 comprising a first magnetic field source 501 (e.g., a permanent magnetic, and electromagnet, or a combination thereof), an HF electric field source 502 (e.g., meander shape coil conductor, stand coil conductor, etc.), and an LF electric field source 503 (e.g., meander shape coil conductor, stand coil conductor, etc.). In some embodiments, HF resonating waves 506 (e.g., ultrasonic modes) may be generated within pipeline 112 via electromotive interaction 507 between magnetic field(s) emitted by magnetic field source 501 and HF electric field(s) emitted by HF electric field source 502. LF resonating waves 508 (e.g., vibrational modes) may be generated within pipeline 112 via electromotive interaction 509 between magnetic field(s) emitted by magnetic field source 501 and LF electric field(s) emitted by LF electric field source 503. In the absence of specific damage within the section of pipeline 112 being scanned, HF resonating waves 506 and LF resonating waves 508 coexist without interaction. However, pipeline 112 may include damage 510 (e.g., defects within the wall of pipeline 112) which may result in nonlinear interactions 511 between HF resonating waves 506 and LF resonating waves 508. The nonlinear interactions 511 may cause frequency and/or amplitude modulations of the HF resonating waves 506 by the LF resonating waves 508. Device 500 also includes sensor module 504, which is an exemplary implementation of sensor 107. In some embodiments, sensor module 504 may comprise a second magnetic field source 512 and an HF electric field receiver 513 configured to detect modulated signals, caused by the nonlinear interactions 511, via electromotive interaction with the magnetic field(s) emitted by the second magnetic field source 512.

Device 500 may also include a Signal Generation, Data Acquisition, and Signal Processing (GAP) module 505, which is an exemplary implementation of communication and control device 108. In some embodiments, GAP module 505 may comprise a processor 514, an HF signal generator 515, HF amplifier(s) 517, an LF signal generator 516, and LF amplifier(s) 518. Processor 514 may be configured to receive, and process modulated signals detected by sensor module 504. In some embodiments, processor 514 may utilize one or more of a plurality of algorithms to process the received signals including, but not limited to: spectral analysis for extraction of a modulation index, advanced AM and FM separation algorithms, correlation and higher order spectrum analysis, other processing techniques depending on complexity of the utilized waveforms, or a combination thereof. Further, processor 514 may be configured to detect damage to pipeline 112 via analysis of extracted damage-related data features (e.g., DP values) calculated based on the processed modulated signals resulting from nonlinear interactions 511. For example, extracted data features on which DP values may be based include, but are not limited to, modulation index, nonlinear correlation factor, or a combination thereof. Additionally, processor 514 may also be configured to control HF signal generator 515 to provide a driving signal to HF electric field source 502, any necessary amplification provided to the signal via HF amplifier(s) 517. Similarly, processor 514 may be configured to control LF signal generator 515 to provide a driving signal to LF electric field source 503, any necessary amplification provided to the signal via LF amplifier(s) 518. In other embodiments, the driving means (e.g., HF signal generator 515, HF amplifier(s) 517, an LF signal generator 516, and LF amplifier(s) 518), or any component thereof, for the HF electric field source 502 and/or the LF electric field source may be housed external to GAP module 505. In some embodiments, the driving means (e.g., HF signal generator 515, HF amplifier(s) 517, an LF signal generator 516, and LF amplifier(s) 518), or any component thereof, for the HF electric field source 502 and/or the LF electric field source may be controlled independently of processor 514.

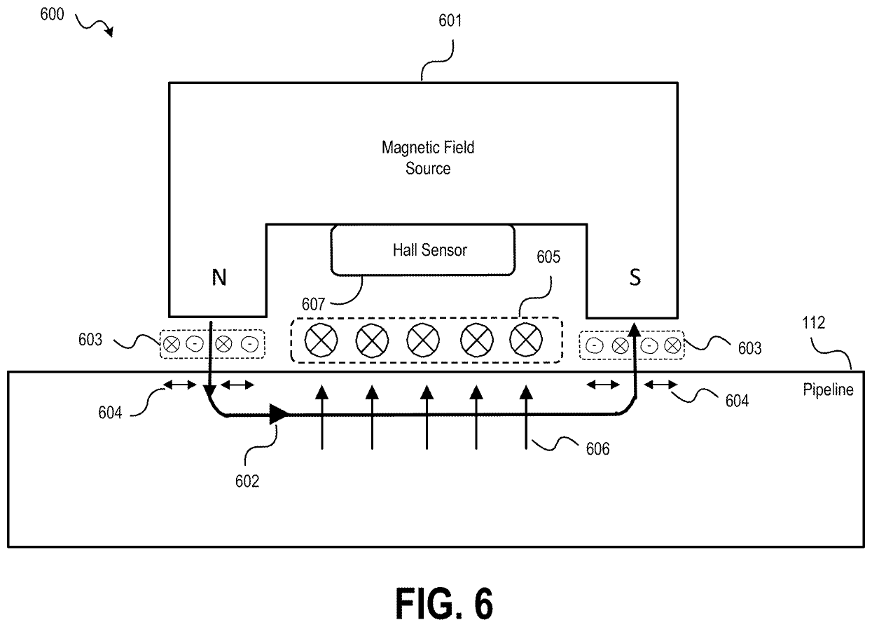

Referring to FIG. 6, a block diagram of pipe scanning device 600 is shown, which illustrates an alternative implementation of pipe scanning device 500 that utilizes a single magnetic field source 601 for the generation of resonating waves within pipeline 112 as well as for the detecting of nonlinear interactions between those resonating waves as opposed to utilizing distinct magnetic field sources 501 and 512, as in pipe scanning device 500. In some embodiments, magnetic field source 601 (e.g., a permanent magnetic, and electromagnet, or a combination thereof) may include two magnetic poles, designated N and S in FIG. 6. Magnetic field source 601 may emit a magnetic field 602 from magnetic pole N to magnetic pole S. In some embodiments, magnetic field source 601 may be positioned relative to the wall of pipeline 112 such that section(s) of magnetic field 602 located just under the magnetic poles N and S may be oriented orthogonal to the outer surface of pipeline 112 and such that section(s) of magnetic field 602 located between magnetic poles N and S may be oriented coplanar to the outer surface of pipeline 112 and parallel to the lengthwise direction of pipeline 112.

In some embodiments, HF electric field source 502 (e.g., meander shape coil conductor, stand coil conductor, etc.) may be positioned such that section(s) of the emitted HF electric field(s) 603 oriented coplanar to the outer surface of pipeline 112 and transverse to the lengthwise direction of pipeline 112 may intersect with section(s) of magnetic field 602 oriented orthogonal to the outer surface of pipeline 112. Electromotive interaction between the intersecting sections of HF electric field(s) 603 and magnetic field 602 may result in the generation of mechanical Lorentz force(s) 604 oriented coplanar to the outer surface of pipeline 112. As a result of the high frequency directional oscillation of HF electric field(s) 603, the corresponding Lorentz force(s) 604 likewise oscillate directionally at high frequency in-plane with the outer surface of pipeline 112, thereby resulting in the generation of HF resonating waves 506 (e.g., ultrasonic modes) within pipeline 112.

In some embodiments, LF electric field source 503 (e.g., meander shape coil conductor, stand coil conductor, etc.) may be positioned such that section(s) of the emitted LF electric field(s) 605 oriented coplanar to the outer surface of pipeline 112 and transverse to the lengthwise direction of pipeline 112 may intersect with section(s) of magnetic field 602 oriented coplanar to the outer surface of pipeline 112 and parallel to the lengthwise direction of pipeline 112. Electromotive interaction between the intersecting sections of LF electric field(s) 605 and magnetic field 602 may result in the generation of mechanical Lorentz force(s) 606 oriented orthogonal to the outer surface of pipeline 112. As a result of the low frequency directional oscillation of LF electric field(s) 605, the corresponding Lorentz force(s) 606 likewise oscillate directionally at low frequency orthogonal to the outer surface of pipeline 112, thereby resulting in the generation of LF resonating waves 508 (e.g., vibrational modes) within pipeline 112.

In some embodiments, device 600 may include at least one magnetic flux leakage sensor module for detecting nonlinear interactions between HF resonating waves 506 and LF resonating waves 508 indicating damage to pipeline 112, which is an exemplary implementation of sensor module 504. A magnetic flux leakage sensor module of device 600 may comprise the same magnetic field source 601 utilized to generate the resonating waves within pipeline 112 as well as a Hall sensor 607. A magnetic flux leakage sensor of device 600 may be configured to detect frequency and/or amplitude modulations of the HF resonating waves 506 by the LF resonating waves 508 indicating damage to pipeline 112.

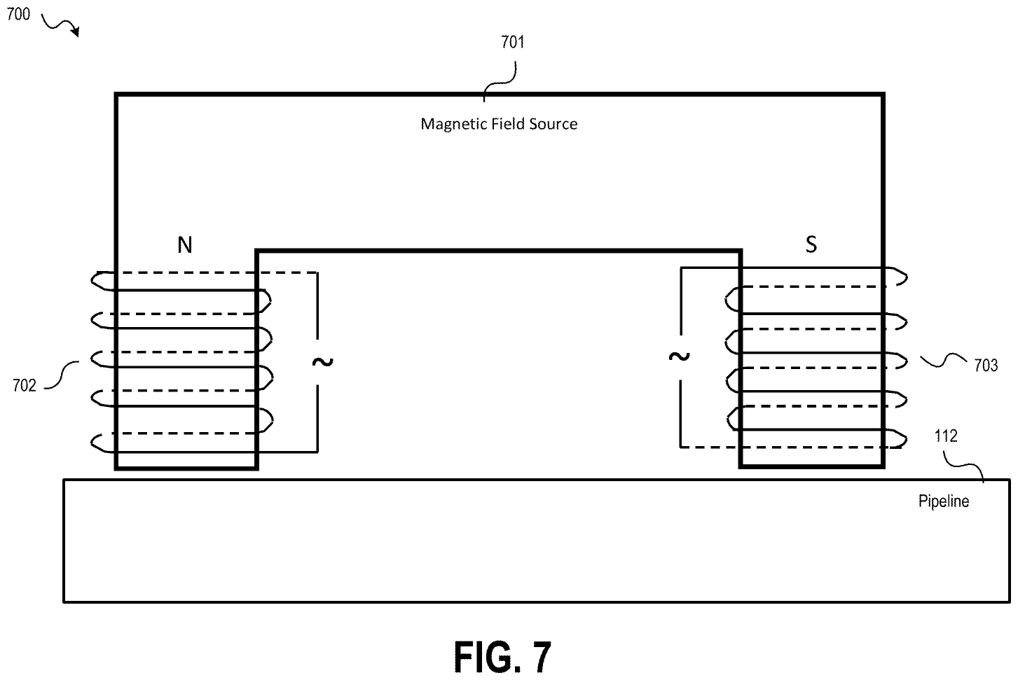

Referring to FIG. 7, a block diagram of pipe scanning device 700 is shown, which illustrates an alternative implementation of pipe scanning device 600 wherein LF resonating waves 508 are generated via variable magnetic attraction (VMA). In some embodiments, device 700 may include a magnetic field source 701, comprising a permanent magnet having two magnetic poles N and S, which is an exemplary implementation of magnetic field source 501 utilized for generating resonating waves within pipeline 112 as described above with regard to FIGS. 5 and 6. Additionally, magnetic field source 701 may simultaneously be utilized for detection of nonlinear interactions indicating damage to pipeline 112 via inclusion in an MFL sensor module, as described above with regard to FIG. 6. Device 700 may also include electric coils 702 and 703 coiled around the magnetic poles N and S, respectively, of magnetic field source 701. Electric coils 702 and 703 may be configured so as to generate directionally alternating (i.e., time-varying) magnetic fields superimposed onto the static magnetic field emitted by magnetic field source 701, the alternating fields emitted by both electric coils 702 and 703 having the same alternating frequency. Accordingly, the resulting magnetic force on ferromagnetic pipeline 112 oscillates (i.e., varies in magnitude with respect to time) according to the alternating frequency of the magnetic fields emitted by electric coils 702 and 703. As a distributed mass/spring mechanical system, pipeline 112 resonates at different temporal frequencies corresponding to particular spatial patterns called modes of vibration. Each vibrational mode of pipeline 112 corresponds to a particular excitation frequency dependent on physical characteristics of pipeline 112 (e.g., pipeline material, pipeline length, pipeline circumference, pipeline wall thickness, presence of insulation on pipeline wall, etc.). Therefore, the alternating frequency applied to electric coils 702 and 703 may generate vibrational modes within pipeline 112 when tuned to particular frequencies, thereby generating LF resonating waves within pipeline 112 via VMA between the time-varying magnetic fields emitted by electric coils 702 and 703 and the surface of pipeline 112.

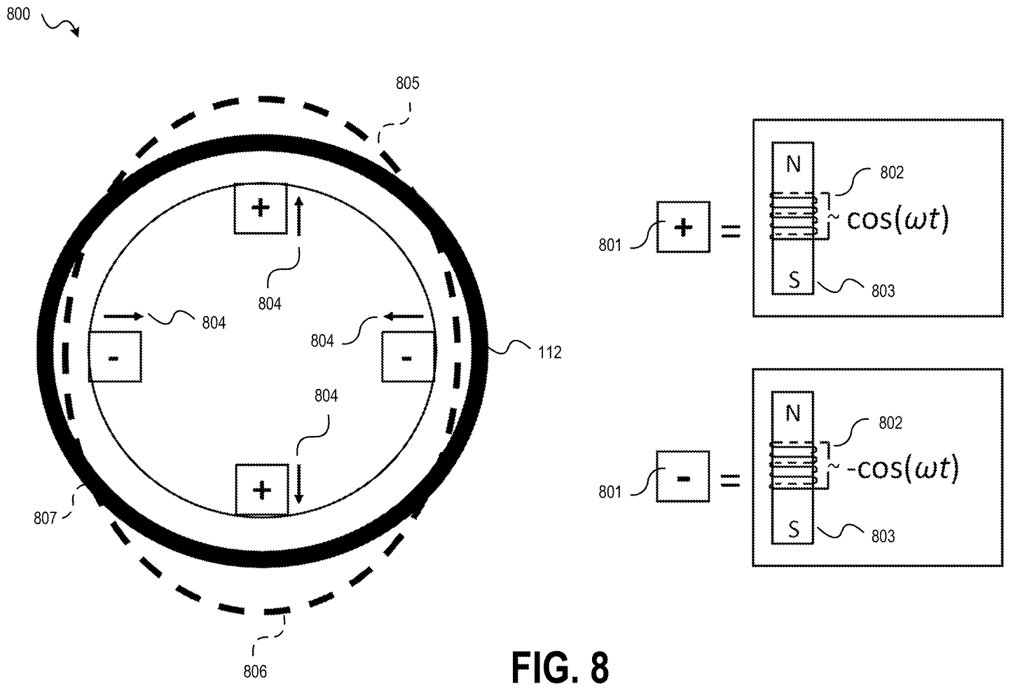

Referring to FIG. 8, a block diagram of pipe scanning device 800 is shown, which illustrates an alternative configuration of pipe scanning device 700 that provides increased capability for optimization and/or fine tuning of defect detection sensitivity. In some embodiments, device 800 may include a plurality of pairs of excitation modules 801. Excitation modules 801 may comprise, at least, an electric coil 802 coiled around a permanent magnet 803 having two magnetic poles N and S. In some embodiments, one or more excitation module(s) 801 may also comprise at least one HF electric field source, at least one additional magnetic field source, at least one additional LF electric field source, at least one sensor for detecting nonlinear interactions between HF and LF resonating waves, or a combination thereof. Excitation modules 801 may be configured to generate LF resonating waves within pipeline 112 via VMA between time-varying magnetic fields emitted by electric coils 802 and the surface of pipeline 112, as described above with regard to FIG. 7. As shown in FIG. 8, the two excitation modules 801 of each pair of excitation modules may be positioned at mirrored locations around the circumference of pipeline 112 and may be electrically phase-matched (i.e., the alternating frequencies applied to the electrical coils 802 of both excitation modules 801 within a pair have equal phase) with respect to each other. Further, the excitation modules 801 of each pair of excitation modules may be electrically phase-mismatched (i.e., the alternating frequency applied to the electrical coils 802 of excitation modules 801 of one pair of excitation modules have a different phase than the alternating frequency applied to the electrical coils 802 of excitation modules 801 of another pair of excitation modules) with respect to every other pair of excitation modules (e.g., one pair of excitation modules 801 is driven by an alternating frequency having a 180° difference in phase from the alternating frequency driving the other pair of excitation modules 801).

As shown in FIG. 8, the plurality of pairs of excitation modules exert an arrangement of magnetic forces 804 on pipeline 112 so as to generate at least one vibrational mode 805 (i.e., LF resonating waves) within pipeline 112. In some embodiments, the vibrational mode(s) generated within pipeline 112 may be standing modes having antinodal regions 806 of high vibration and nodal regions 807 of low vibration. Due to the weaker vibrational level on the nodal regions 807, defects in those regions along the wall of pipeline 112 may result in reduced levels of modulation between HF and LF resonating waves indicative of damage. Similarly, defects in the antinodal regions 806 along the wall of pipeline 112 may result in higher levels of modulation between HF and LF resonating waves indicative of damage due to the stronger vibrational level in those regions. Accordingly, regions having higher/lower detection sensitivity may be fine-tuned and/or optimized based on the positioning of excitation modules 801 around the circumference of pipeline 112. In other embodiments, additional pairs of excitation modules (e.g., 4 pairs, 6 pairs, 8 pairs, 10 pairs, etc.) may be utilized so as to increase the coverage of antinodal regions around the circumference of pipeline 112, thereby reducing regions of low detection sensitivity around the pipeline. Additionally, in some embodiments, fine-tuning and/or optimization of detection sensitivity around the circumference of pipeline 112 may be implemented by varying the alternating frequency applied to excitation modules 801, while maintaining the phasing between excitation module pairs as described above, so as to induce higher order vibrational modes within pipeline 122 that have more antinodal regions. In other embodiments, a rotating vibrational mode, as opposed to a standing mode, may be implemented using additional pairs of excitation modules (e.g., 4 matched pairs of excitation modules) and phase switching between the pairs so as to rotate the antinodal regions around the circumference of pipeline 112, thereby distributing regions of increased detection sensitivity more evenly around the circumference of the pipeline. Embodiments utilizing rotating vibrational modes provide for further degrees of fine-tuning and/or optimization of detection sensitivity by allowing control over the positioning of regions having higher/lower detection sensitivity via phase switching between the pairs of excitation modules. It is noted that although the embodiments illustrated by FIG. 8 disclose excitation modules 801 generating vibrational modes (i.e., LF resonating waves) from within pipeline 112, in other embodiments excitation modules 801 may be configured and positioned to generate vibrational modes (i.e., LF resonating waves) inside of pipeline 112 from the exterior of pipeline 112.

As noted with respect to the exemplary embodiments described above, in some embodiments, the sensor(s) 107 of pipe scanning device 101 may be configured such that nonlinear interactions between HF resonating wave modalities and LF resonating wave modalities within in a pipeline (e.g., frequency and/or amplitude modulations of the HF resonating wave modalities by the LF resonating wave modalities) corresponding to pipeline wall defects may be detected as electronic signals to be transmitted to communication and control system 108 as scan data. Communications and control system 108 may be configured to utilize one or more algorithms (e.g., spectral analysis for extraction of a modulation index, advanced AM and FM separation algorithms, correlation and higher order spectrum analysis, other processing techniques depending on complexity of the utilized waveforms, or a combination thereof) to process received scan data. Based on processed scan data, communications and control system 108 may extract damage-related data features including, but not limited to, modulation index, nonlinear correlation factor, or a combination thereof, and calculate DP values based on the one or more damage related features. Communications and control system 108 may associate calculated DP values with specific positions along the length of the pipeline based on received orientation data (e.g., pipeline foot marker, scan timestamp, a combination thereof, etc.) correlating to each portion of scan data and, based on these associations, may determine a distribution of DP values over a length of pipeline. Communications and control system 108 may determine DP value distributions over sections of pipeline either periodically, as scans of pipeline sections are completed, or continuously, as each portion of scan data is received and processed.

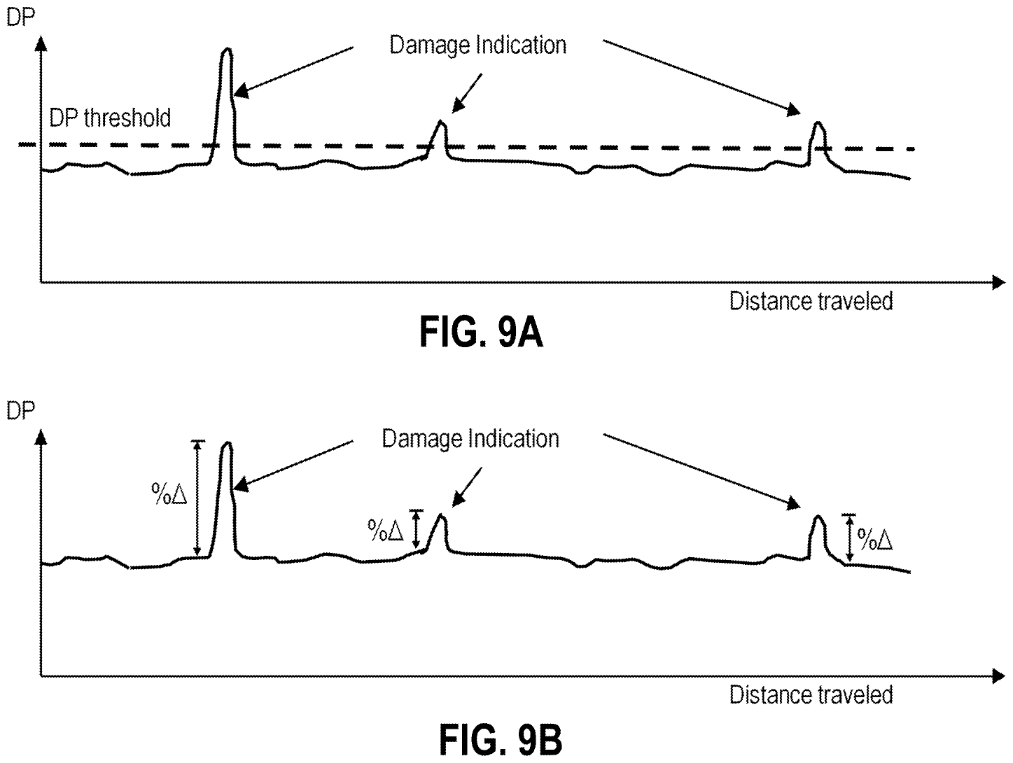

The determination of distributions of DP values over sections of pipeline, as described above, allow pipeline wall condition for each location along a length of pipeline to be analyzed and for pipeline damage present at any location to be detected based on DP value distributions. For example, FIG. 9A illustrates an exemplary approach for detecting pipeline defects based on a DP value distribution in accordance with some embodiments. More specifically, FIG. 9A shows an exemplary distribution of DP values determined along a length of pipeline as well as a DP threshold. In some embodiments, a DP threshold value may be established and communications and control system 108 may compare DP values associated with locations along the pipeline to the DP threshold value in order to detect any pipeline wall damage at those locations. For example, in the illustration of FIG. 9A any excursion of DP values beyond the DP threshold value indicates pipeline damage at that location.

In some embodiments, a DP threshold value may be established by a user and provided to pipe scanning device 101. In other embodiments, communications and control system 108 of pipe scanning device 101 may set a DP threshold value itself (e.g., based on historical DP values from the current scan or from previous scans, on pipeline parameters input by the user, on a combination thereof, etc.). In some embodiments, communications and control system 108 may update a DP threshold value dynamically based on DP values as the DP value distribution is updated. For example, communications and control system 108 of pipe scanning device 101 may calculate DP values over a portion of the total length of a pipeline section under inspection, at which point communications and control system 108 may calculate an average of the damage parameter values over that particular section and determine a DP value threshold based on that average damage parameter value.

It is noted that different pipe characteristics (e.g., pipe grade, coating, thickness, etc.) may provide different baseline DP values (e.g., DP values that may fluctuate to some degree but do not exhibit spikes as shown in FIG. 9A) and a pipeline under inspection by pipe scanning device 101 may include sections of pipeline having different characteristics. In some embodiments, when adjacent pipeline sections having different characteristics are present, detection of a change in the baseline DP value by communications and control system 108 may signify a change in pipe characteristics from one section of pipeline to the next section and, therefore, communications and control system 108 may determine to dynamically adjust the DP threshold value as a result so as to factor the variation in pipeline characteristics into the damage detection analysis. For example, in some embodiments, communications and control system 108 may determine to dynamically adjust the DP threshold value by comparing DP values prior to detection of a baseline DP value variation (e.g., indicating a variation in pipeline characteristics from section to section of pipeline) to DP values calculated after detection of the baseline DP value variation and update the threshold DP value based on that comparison. In other embodiments, pipe scanning device 101 may include or may be communicatively coupled to additional sensor(s) configured to detect pipeline characteristics (e.g., indicators of pipe grade, coating, thickness, etc.) other than pipeline wall damage indicators and communications and control system 108 may determine to dynamically adjust/update the DP threshold by comparing pipeline characteristics from section to section of pipeline based on data received from those additional sensor(s).

In some embodiments, communications and control system 108 of pipe scanning device 101 may be configured to detect pipeline wall damage based on a percent change in calculated DP values rather than based on comparing calculated DP values to a threshold. For example, FIG. 9B illustrates an exemplary approach for detecting pipeline defects based on percent changes between DP values in a DP value distribution in accordance with some embodiments. More specifically, FIG. 9B shows an exemplary distribution of DP values determined along a length of pipeline wherein the distribution features several DP value data spikes. In some embodiments, communications and control system 108 may be configured to detect sudden increases or spikes (e.g., % Δ as shown in FIG. 9B) in the DP value distribution for a section of pipeline and detect pipeline wall damage at pipeline locations associated with those spikes (e.g., a change in DP value of X % representing a spike above the baseline DP value). In some embodiments, the magnitude of percent change in DP values required for communications and control system 108 to detect pipeline wall damage may be established by a user and provided to pipe scanning device 101. In other embodiments, communications and control system 108 of pipe scanning device 101 may set magnitude of percent change required itself (e.g., based on historical DP values from the current scan or from previous scans, on pipeline parameters input by the user, on a combination thereof, etc.). In some embodiments, communications and control system 108 may update a magnitude of percent change required dynamically (e.g., based on DP values as the DP value distribution is updated, on received pipe characteristics data, etc.). Additionally, in some embodiments, communications and control system 108 may be configured to detect pipeline wall damage based on a combination of both detecting percent changes between calculated DP values as well as comparing calculated DP values to a threshold value. Utilizing either or both approaches eliminates the need for absolute calibration of the detection system and further improves the sensitivity of detection and lower the false alarm rate.

With regard to the above-described pipeline damage detection approaches, it should be noted that, in some embodiments, communications and control system 108 of pipe scanning device 101 may be configured to detect damage to the pipeline based on the calculated DP values as described and then indicate the presence and location of the damage to a user upon detection (e.g., via a visual and/or auditory alert, via a damage report, etc.). In other embodiments, communications and control system 108 may be configured to summarize DP values calculated over a length of pipeline for a user (e.g., via DP value logs, via graphical representations of the DP value distributions, etc.) and the user may make a determination as to whether the DP values reported by communications and control system 108 indicate damage to the pipeline. Moreover, in additional to pipeline damage detection, the above-described detection approaches may also be used for other purposes, such as to detect pipe characteristics (e.g., thickness, grade, coating, etc.) based on the baseline DP values, thereby providing a mechanism to characterize new features of a pipeline (e.g., enabling identification and quantification of the structure of a pipeline).

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Additionally, it should be understood that scanning systems in accordance with the present disclosure have been described and illustrated with respect to specific embodiments for purposes of illustration, rather than by way of limitation and features of a particular embodiment may be utilized in combination with features described with respect to other embodiments. Accordingly, the appended claims are intended to include within their scope such processes, machines, manufacture, compositions of matter, means, methods, or steps.

Moreover, the scope of the present application is not intended to be limited to the particular embodiments of the process, machine, manufacture, composition of matter, means, methods and steps described in the specification.

What is claimed is:

1. A method for detecting defects in a pipeline, comprising:
generating one or more high frequency resonating waves inside a circumferential section of the pipeline;
generating one or more low frequency resonating waves inside the circumferential section of the pipeline;
detecting one or more nonlinear interactions between the high frequency resonating waves and the low frequency resonating waves;
calculating one or more damage parameter values based on the one or more nonlinear interactions; and
detecting damage to the pipeline based on the one or more damage parameter values.

2. The method of claim 1, wherein the damage is detected by comparing the one or more damage parameter values to a threshold damage parameter value.

3. The method of claim 2, further comprising dynamically updating the threshold damage parameter value.

4. The method of claim 3, wherein different threshold damage parameter values are associated with different sections of the pipeline.

5. The method of claim 4, further comprising:
detecting one or more characteristics associated with a first section of the pipeline and a second section of the pipeline;
comparing the one or more characteristics associated with the first section of the pipeline and the second section of the pipeline;
determining to dynamically update the threshold damage parameter value based on the comparing.

6. The method of claim 1, further comprising detecting a spike in the one or more damage parameter values, wherein a spike is detected based on a percent change between a first damage parameter value and a second damage parameter value.

7. The method of claim 1, wherein the generating one or more high frequency resonating waves, the generating one or more low frequency resonating waves inside the circumferential section of the pipeline, and the detecting one or more nonlinear interactions between the high frequency resonating waves and the low frequency resonating waves are implemented by a first measurement module mounted onto a pipeline inspection gauge (“PIG”).

8. The method of claim 7, further comprising detecting one or more additional characteristics of the pipeline via one or more additional sensors of the PIG, wherein the one or more additional characteristics are different from the one or more nonlinear interactions between the high frequency resonating waves and the low frequency resonating waves, and wherein the one or more additional sensors are different from the first measurement module.

9. The method of claim 1, wherein the one or more nonlinear interactions are detected via one or more magnetic flux leakage sensors.

10. The method of claim 1, wherein the one or more high frequency resonating waves are generated via electromotive interaction between a section of a magnetic field oriented orthogonal to an outer surface of the pipeline and one or more high frequency electric fields oriented coplanar to the outer surface of the pipeline and transverse to a lengthwise direction of the pipeline.

11. The method of claim 1, wherein the one or more low frequency resonating waves are generated via electromotive interaction between a section of a magnetic field oriented coplanar to the outer surface of the pipeline and parallel to the lengthwise direction of the pipeline and one or more low frequency electric fields oriented coplanar to the outer surface of the pipeline and transverse to the lengthwise direction of the pipeline.

12. The method of claim 1, wherein the one or more low frequency resonating waves are generated via variable magnetic attraction between a time-varying magnetic field and a surface of the pipeline.

13. The method of claim 1, wherein the one or more high frequency resonating waves and the one or more low frequency resonating waves are generated by at least two pairs of excitation modules, wherein the excitation modules within each pair are electrically phase-matched with respect to each other, and wherein each pair of excitation modules is electrically phase-mismatched with respect to every other pair of the at least two pairs of excitation modules.

14. The method of claim 1, wherein each of the one or more damage parameter values correlates with a length along the pipeline.

15. A system for detecting defects in a pipeline, comprising:
a magnetic field source;
a first electric field source configured to emit one or more high frequency electric fields, wherein one or more high frequency resonating waves are generated inside a circumferential section of the pipeline via electromotive interaction between the one or more high frequency electric fields and a magnetic field emitted by the magnetic field source;
a second electric field source configured to emit one or more low frequency electric fields, wherein one or more low frequency resonating waves are generated inside the circumferential section of the pipeline via electromotive interaction between the one or more low frequency electric fields and the magnetic field emitted by the magnetic field source;
a sensor configured to detect one or more nonlinear interactions between the high frequency resonating waves and the low frequency resonating waves; and
a processor communicatively coupled to the sensor, wherein the processor is configured to:
calculate one or more damage parameter values based on the one or more nonlinear interactions; and
detect damage to the pipeline based on the one or more damage parameter values.

16. The system of claim 15, wherein the processor detects the damage by comparing the one or more damage parameter values to a threshold damage parameter value.

17. The system of claim 16, wherein the processor updates the threshold damage parameter value dynamically, wherein different threshold damage parameter values are associated with different sections of the pipeline, wherein the processor is further configured to:
detect one or more characteristics associated with a first section of the pipeline and a second section of the pipeline;
compare the one or more characteristics associated with the first section of the pipeline and the second section of the pipeline; and
determine to dynamically update the threshold damage parameter value based on the comparing.

18. The system of claim 15, wherein the processor is further configured to detect at least one spike in the one or more damage parameter values based on a percent change between a first damage parameter value and a second damage parameter value.

19. The system of claim 15, further comprising a first measurement module mounted onto a pipeline inspection gauge (“PIG”), wherein the first measurement module includes the magnetic field source, the first electric field source, the second electric field source, and the sensor.

20. The system of claim 15, wherein a first section of the magnetic field is oriented orthogonal to an outer surface of the pipeline, and wherein the one or more high frequency electric fields are oriented coplanar to the outer surface of the pipeline and transverse to a lengthwise direction of the pipeline.
